(19) United States
(12) Patent Application Publication
(10) Pub. No.: US 2003/0178801 A1
(43) Pub. Date: Sep. 25, 2003

(54) Motorized wheelbarrow with handle elevating feature

(76) Inventor: Richard D. Hart, Grass Valley, CA (US)

Correspondence Address: John P. Costello, Weintraub Genshlea Chediak Sproul, 11th Floor, 400 Capitol Mall, Sacramento, CA, 95814, US

(21) Appl. No.: 10/365,263

(22) Filed: Feb. 11, 2003

Related U.S. Application Data
(60) Provisional application No. 60/357,521, filed on Feb. 12, 2002.

(51) Int. Cl. B62B 3/00; B62B 11/00

(52) U.S. Cl. 280/47.371

(57) ABSTRACT

An inventive wheelbarrow incorporating two inline wheels, front and rear, for supporting the weight of the wheelbarrow and any load placed thereon, is disclosed. The two inline wheels are preferably identical and can be interchanged between front and rear and can be fitted with a sprocket, or drive pulley, which, in turn, communicates with a motor through a drive belt or chain. The motor can be fuel or electric and can include a power-take-off (PTO) option for powering a number of exterior appliances such as a power generator or a water pump. The inventive wheelbarrow also includes a handle elevating feature which allows the handles to be raised or lowered, depending on operator preferences. By raising the handles, the load is supported on the inline wheels and not on the shoulders and arms of the operator. With the weight supported on the inline wheels, the operator's main function is to balance the load as the wheelbarrow travels forward. The inventive wheelbarrow results in a significant reduction in user fatigue and the carrying of heavy loads for several miles, by a single operator, is possible.

### CROSS REFERENCE TO RELATED APPLICATIONS

This utility patent application claims the benefit of U.S. provisional serial No. 60/357,521 filed on Feb. 12, 2002.

### FIELD OF THE INVENTION

This invention relates to wheelbarrow devices generally, and more specifically, to motorized wheelbarrows.

### BACKGROUND

Wheelbarrows have been in use for many years and allow an operator a simple way to easily move a variety of weighty cargoes. The basic wheelbarrow is comprised of a frame coupled to a cargo bucket, a supporting wheel or wheels, support legs and a pair of handles for lifting and pushing the wheelbarrow forward. To overcome the inherent limits in human endurance, motors have been added to wheelbarrows to further increase their capabilities and usefulness. Examples of motorized wheelbarrow inventions can be seen in U.S. Pat. No. 5,878,827 (Fox), U.S. Pat. No. 5,489,000 (Hillbohm), U.S. Pat. No. 5,465,801 (Hoover), U.S. Pat. No. 4,811,988 (Immel), U.S. Pat. No. 4,589,508 (Hoover et al.), Des. No. 357,101 (Uyehara et al.) and in U.S. patent application Pub. No. 2002/0084119 (Brabetz et al.).

The aforementioned patents and patent applications describe wheelbarrows that are powered by small gasoline or electric motors. However, save for the addition of a motor, the basic wheelbarrow design remains unchanged in the mentioned references.

A problem with present wheelbarrow design is that an operator must bear the weight of the loaded wheelbarrow on his arms and shoulders, which soon leads to operator fatigue, regardless of whether the wheelbarrow is motorized.

The addition of lateral support wheels have been added to some designs (e.g. '827 Fox; '000 Hillbohm) but these wheels are usually small and require the operator to lower the entire wheelbarrow to get the wheels to touch the ground, thereby leaving the operator in a less than optimum position for advancing the wheelbarrow forward.

A need therefore exists for a wheelbarrow which self-supports a load to as great extent as possible, and which also positions the handles in an optimal position to always allow an operator to comfortably advance the wheelbarrow forward.

The foregoing reflects the state of the art of which the inventor is aware, and is tendered with a view toward discharging the inventors' acknowledged duty of candor, which may be pertinent to the patentability of the present invention. It is respectfully stipulated, however, that the foregoing discussion does not teach or render obvious, singly or when considered in combination, the inventor's claimed invention.

### SUMMARY OF THE INVENTION

The inventive wheelbarrow uses two inline wheels, front and rear, for supporting the weight of the wheelbarrow and any load placed thereon. The two inline wheels are preferably identical and can be interchanged between front and rear and can be fitted with a sprocket, or drive pulley, which, in turn, communicates with a motor through a drive belt or chain. The motor can be gasoline or electric and can include a power-take-off (PTO) option for powering a number of exterior appliances such as a power generator or a water pump.

The inventive wheelbarrow also includes a handle elevating feature which allows the handles to be raised or lowered, depending on operator preferences. In the preferred embodiment, the elevating feature is comprised of a modified wheelbarrow frame having a rear catch release which raises and lowers upon an elevating shaft, the shaft having a plurality of holes located at differing heights. When the catch release is selectively disengaged, the operator can raise or lower the rear of the wheelbarrow, and when a desired height is reached, the catch can be re-engaged. The modified frame has pivot points which allow the catch release to slide up and down the shaft with a significant range of motion.

The combination of the inline wheels and handle elevating feature allow an operator to support the weight of the inventive wheelbarrow and its associated load on the wheels, rather than on the shoulders and arms of the operator. The operator's energy is thus left to be used primarily in balancing the wheelbarrow as it advances forward. The addition of a motor further reduces the energy expended by an operator in advancing the inventive wheelbarrow forward.

As such the following objects and advantages are sought to be achieved by the inventive wheelbarrow:

An object of the invention is to provide a wheelbarrow which self-supports the weight of the wheelbarrow and its associated load.

Another object of the invention is to provide a wheelbarrow that can have interchangeable inline wheels.

A still further object is to provide a wheelbarrow which is motorized.

Further objects and advantages of the invention will be brought out in the following portions of the specification, wherein the detailed description is for the purpose of fully disclosing preferred embodiments of the invention, without placing limitations thereon.

### BRIEF DESCRIPTION OF THE DRAWINGS

The invention will be more fully understood by reference to the following drawings which are for illustrative purposes only:

FIG. 1 is a rear perspective view of the inventive wheelbarrow.

FIG. 2 is a bottom view of the inventive wheelbarrow.

FIG. 3 is a side view of the inventive wheelbarrow with the elevating means located in a lowered orientation.

FIG. 4 is a close up perspective view of the elevating shaft and associated catch release mechanism.

FIG. 5 is a side view of the inventive wheelbarrow with the elevating means in a raised orientation.

FIG. 6A is a perspective view of an operator operating the wheelbarrow with the elevating means in a lowered orientation.

FIG. 6B is a perspective view of an operator operating the wheelbarrow with the elevating means in a raised orientation.

FIG. 7A is a close up side view of the front of the inventive wheelbarrow, showing motor mount, accessory plate, motor, inline drive wheel and various belts and pulleys comprising the drive assembly which help power the inline drive wheel.

FIG. 7B is a close up side view opposite from the side shown in FIG. 7A, showing the front of the inventive wheelbarrow, motor mount, accessory plate, motor, inline drive wheel and various belts and pulleys comprising the drive assembly which help power the inline drive wheel.

### DESCRIPTION OF THE PREFERRED EMBODIMENTS

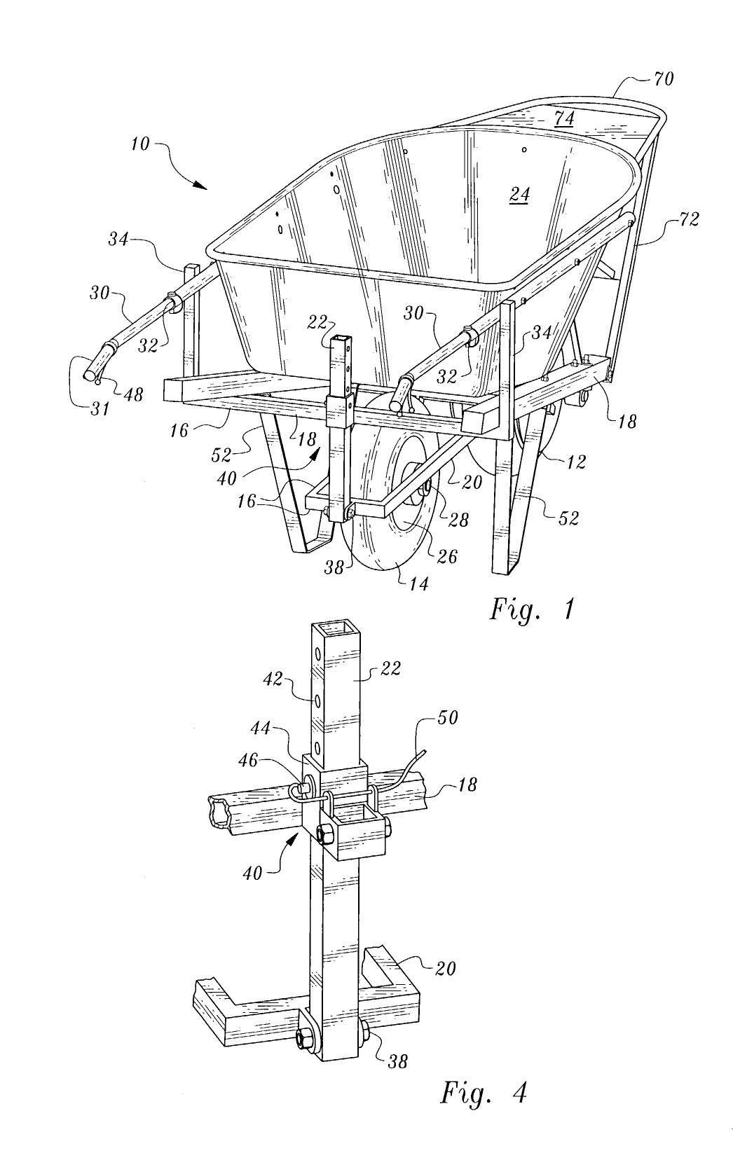

Referring more specifically to the drawings, for illustrative purposes, the present preferred embodiment of the inventive wheelbarrow 10 is shown generally, in FIG. 1. As shown, a pair of inline wheels 12, 14 serve to support a frame 16. Frame 16 is comprised of a main support member 18, a pivotally coupled swing arm 20 and an elevating shaft 22, which will be further described herein. A cargo bucket 24 is coupled to the main support member 18 and positioned atop the inline wheels 12, 14. Inline wheels support the weight of the wheelbarrow and any associated cargo placed within cargo bucket. Inline wheels 12, 14 preferably have a traction surface and are mounted on wheel rims 26. Central within wheel rims are axles 28 which couple to the frame and which rotate in a sealed bearing system.

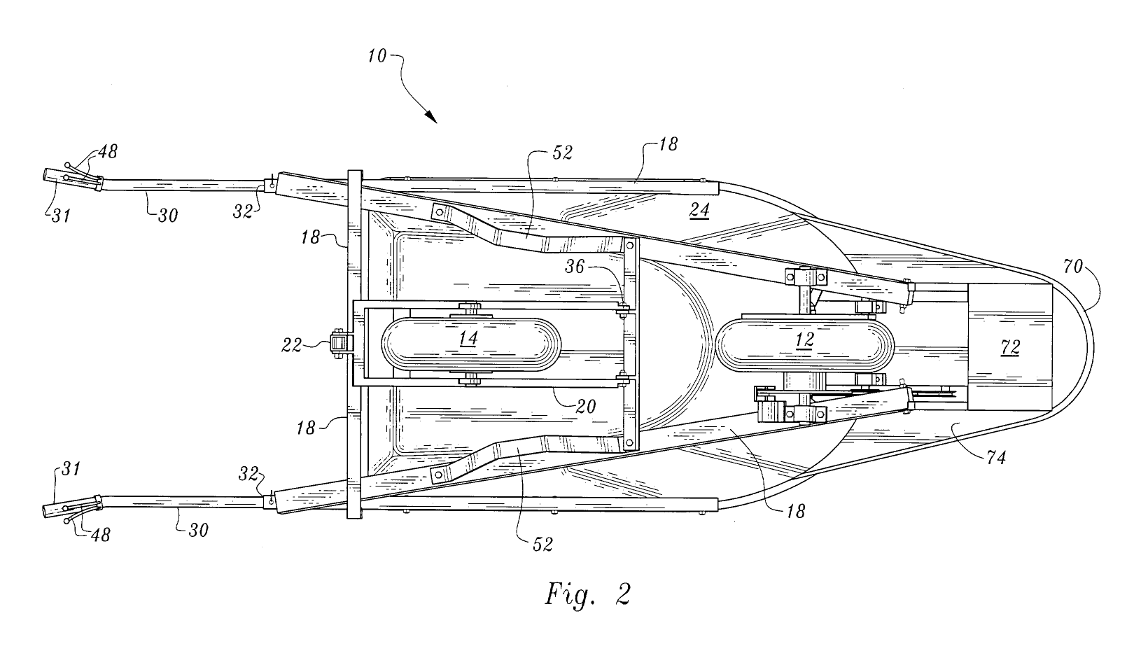

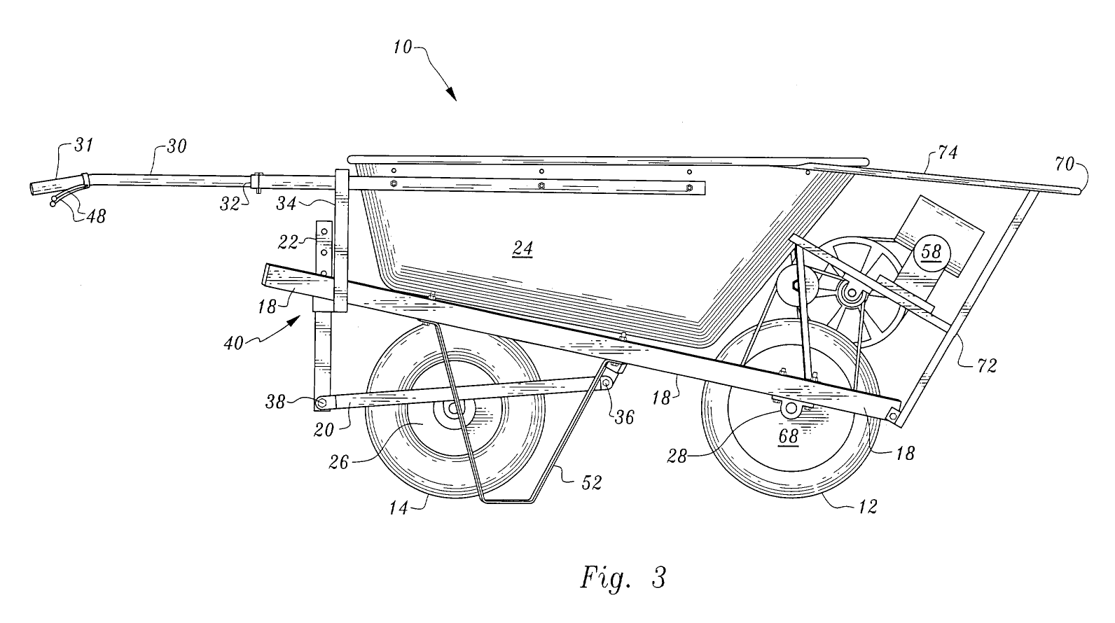

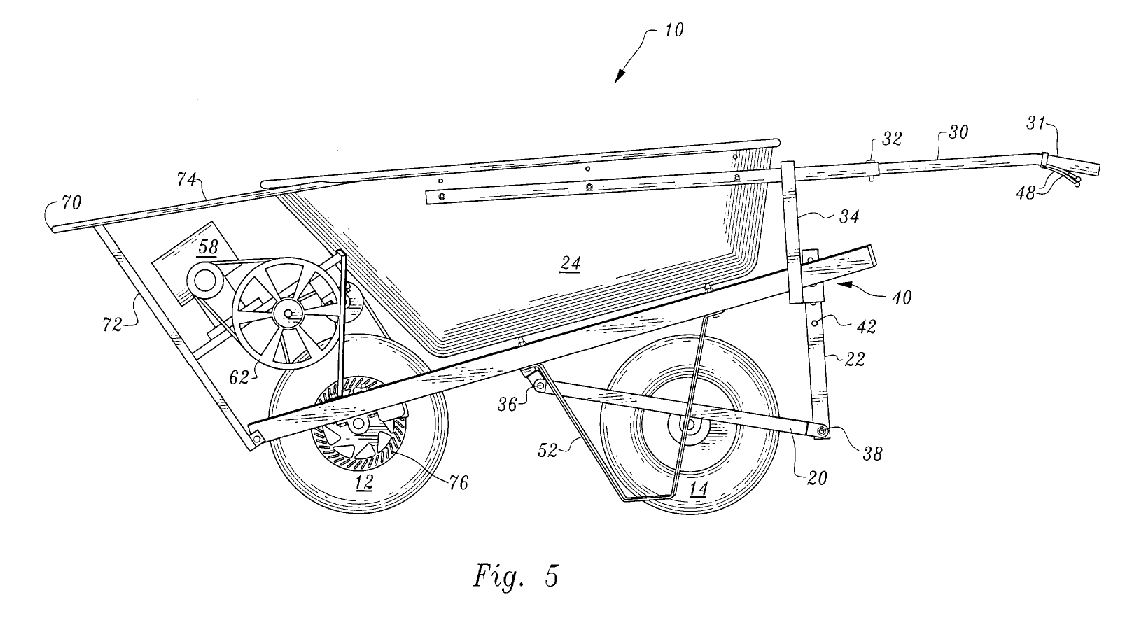

As is more clearly shown in FIGS. 2 and 3, a pair of handles 30 extend rearward of the cargo bucket 24 and include hand grips 31 at the distal ends of handles 30 to allow an operator to comfortably grab hold of the wheelbarrow. Handles 30 can be made to disengage at points 32 if it is desired to break the wheelbarrow down to a smaller profile. Handles 30 are coupled via risers 34 to the lateral sides of main support member 18 and cargo bucket 24. Main support member 18 has a trapezoidal shape, with a narrow end of the trapezoid at the front of the wheelbarrow and a wide end of the trapezoid at the rear. Transposed equidistant between the long sides of main support member 18 are inline wheels 12, 14. Front inline wheel 12 is coupled directly to the front of main support member 18 and rear inline wheel 14 is coupled to swing arm 20. Rear inline wheel 14 is suspended within the confines of swing arm 20 and mounted thereto.

Referring also to FIG. and 4, swing arm 20 is pivotally coupled to main support member at a front pivot point 36, front pivot point being located on main support member 18 between front and rear inline wheels 12, 14. Furthermore, swing arm 20 is pivotally coupled to the lowermost portion of elevating shaft 22 at rear pivot point 38. The elevating shaft 22 and associated catch release 40 comprise a means for elevating the handles 30 and elements associated with the handles. Located longitudinally on elevating shaft 22 above rear pivot point 38 are a plurality of catch holes 42 which cooperate with catch release 40. Catch release 40 is coupled to the rear side of main support member 18 and includes a sleeve 44 which surrounds and slidably engages with elevating shaft 22 and a spring-loaded catch pin 46. The spring loaded catch pin 46 can be engaged or disengaged, at will, using a hand lever 48 attached to a cable 50, the cable 50 operatively engaging the spring-loaded catch pin 46. Upon squeezing the hand lever 48, the catch pin 46 disengages from the catch holes 42 and the operator can subsequently raise or lower the handles 30 separately from the inline wheels 12, 14, which remain in contact with the ground. Upon raising or lowering the handles 30, any items coupled directly or indirectly to the handles will raise and lower as well. Items including the risers 34, support legs 52, the main support member 18 and cargo bucket 24 raise and lower with the handles 30.

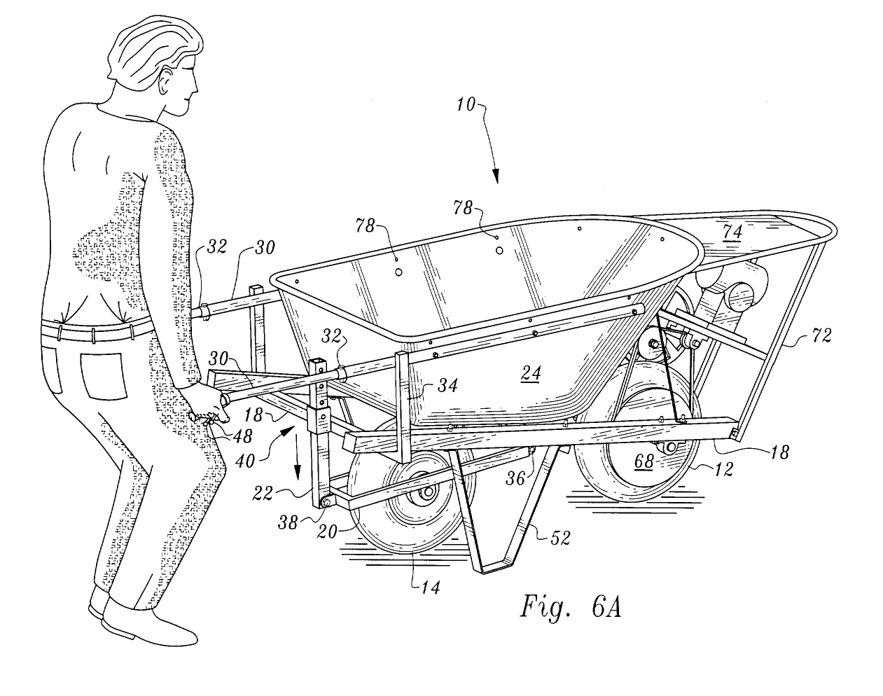

As shown in FIG. 5, when the handles 30 are raised, both inline wheels 12, 14 remain in contact with the ground as the handles and associated items pivot upward and tilt slightly forward. As already noted, the support legs 52 lift off of the ground, leaving significant ground clearance for obstacles as the inventive wheelbarrow is moved. When a desired destination is reached, the catch release 40 can be disengaged and the handles 30 lowered until the support legs 52 touch the ground in a normal manner, as shown in FIG. 3. The catch release 40 can be engaged with the elevating shaft 22, at the lower orientation, and the wheelbarrow left free standing on its support legs 52.

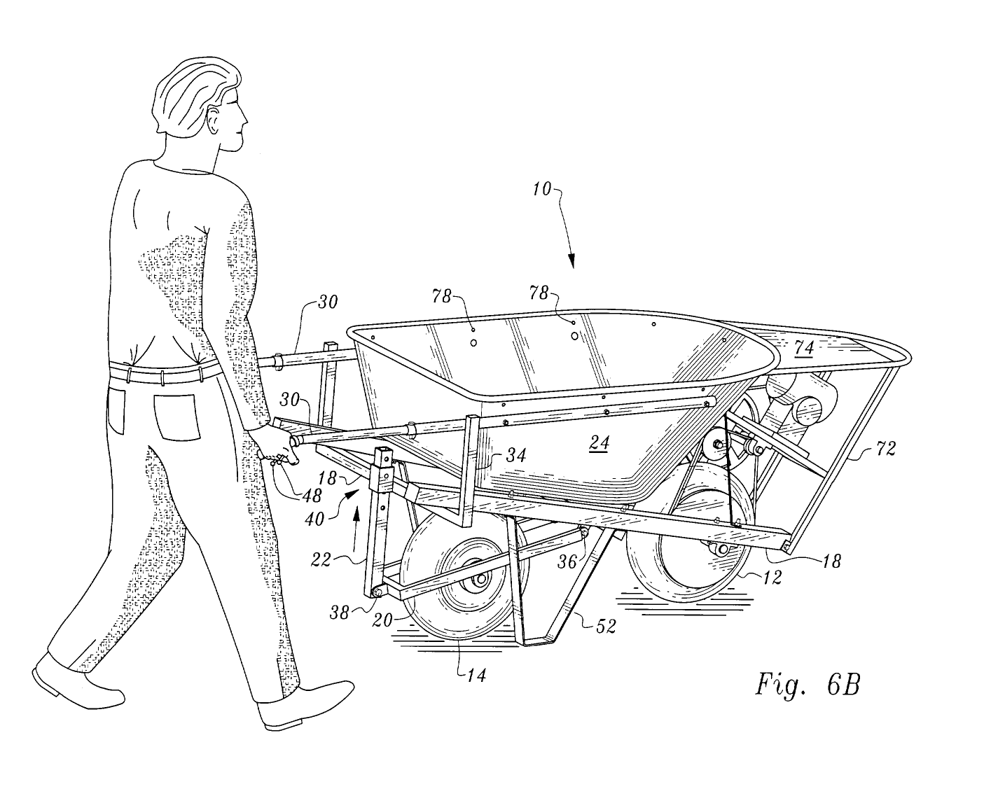

FIGS. 6A and 6B illustrate an operator operating the inventive wheelbarrow 10 with the handles 30 in a first lowered, and secondly, raised orientation, respectively. As shown, in the raised orientation in FIG. 6B, the operator is walking behind the wheelbarrow 10 with the weight of the wheelbarrow and its cargo being born by the inline wheels 12, 14, rather than upon the operator's shoulders and arms. The arrow in FIG. 6A indicates the catch release 40 at a lowered position on elevating shaft and the arrow in FIG. 6B indicates the catch release in the raised position. In typical prior art wheelbarrows, the operator was required to walk between the handles (supporting the weight of the cargo), rather than behind them, as shown with the inventive wheelbarrow 10 in FIG. 6B. The energy expended by the operator is primarily used for guiding and balancing the cargo, rather than bearing its weight. For this reason, with the inventive wheelbarrow an operator can travel significant distances, even up to several miles, over rough terrain, without significant fatigue.

Another benefit of having two inline wheels is the ability to pivot the loaded wheelbarrow on its rear wheel while traversing rocks, curbs or other obstacles with the front wheel. Upon traversing the obstacle with the front wheel, the rear wheel can be gently lifted over the obstacle. This contrasts with traditional wheelbarrows which require the operator to obtain a running start at an obstacle in hopes of “popping” the front wheel over the obstacle. This old technique often results in the operator dumping the load, prematurely, upon trying to regain control of the bouncing wheelbarrow following traversing the obstacle.

The inventive wheelbarrow is preferably motorized. Small electric, four cycle and two cycle motors, mounted to an appropriate location, can all be applied to the inventive wheelbarrow through means well known in the art. The inventor has used the four cycle Honda Model No. GX 31 gasoline engine during experimental development, this engine being favorable because it can operate in any orientation, even upside down, which is important during dumping operations, where the wheelbarrow would be in other than an upright orientation.

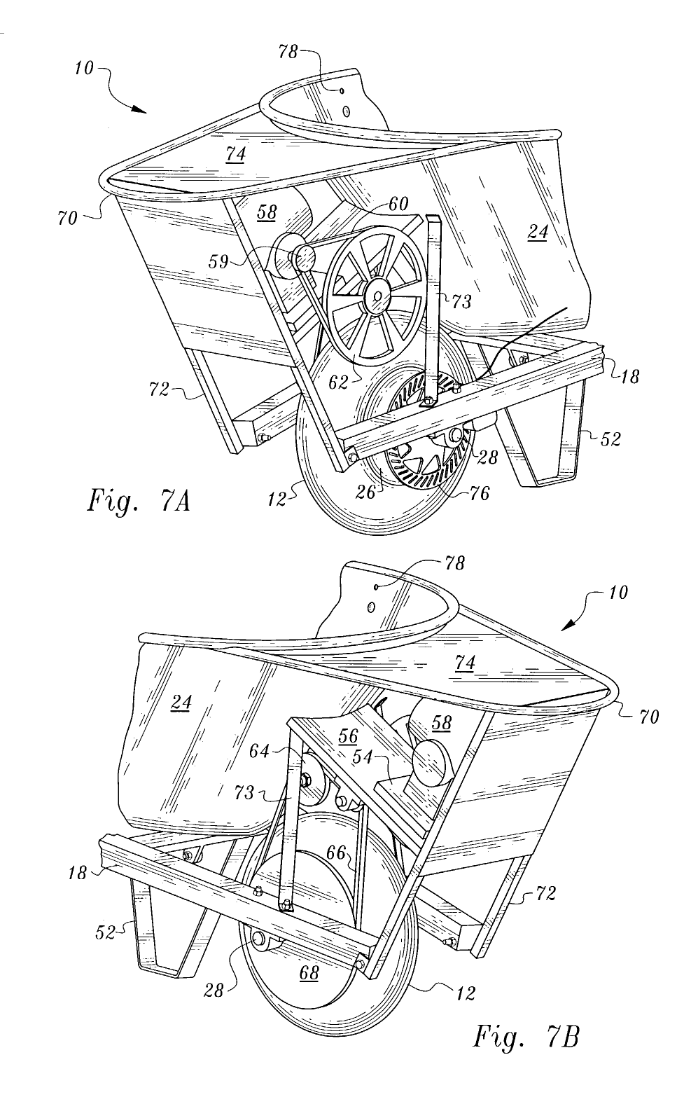

FIGS. 7A and 7B illustrates a view showing the motor mount 54, accessory plate 56, motor 58, inline drive wheel 12, and various belts and pulleys comprising the drive assembly which help power the inline drive wheel 12. The motor 58 is mounted to a motor mount 54 which in turn is mounted to an accessory plate 56 which extends from the front of the wheelbarrow 10. The motor can be easily removed from the motor mount if it is desired to be used to power other equipment. The motor is connected to the drive assembly utilizing a centrifugal clutch, actuated by the engine throttle which is controlled by the operator via cables and the throttle hand lever 48. PTO shafts allow for powering the wheelbarrow as well as external equipment such as pumps, generators, etc. One PTO drive shaft 59 is v-belt connected 60 to a reduction pulley 62. A shaft extends from the reduction pulley to a second pulley 64 opposite the reduction pulley 62, the second pulley being v-belt connected 66 to the inline wheel-mounted drive pulley 68. The drive pulley 68 is rigidly mounted to the front inline wheel 12 using mounting holes in the wheel rim 26, thereby making the front inline wheel a drive wheel. The v-belt 66 which drives the drive wheel 12 can be loosened, thereby enabling the inventive wheelbarrow to be operated without the motor, if desired. The front and rear inline wheels 12, 14 are interchangeable. The wheel-mounted drive pulley 68 will fit either wheel, thereby converting either wheel to a drive wheel, and the wheelbarrow can be operated with only one wheel in the forward position, if necessary.

The front tow connection 70 allows for an external connection to assist in pulling the cargo load contained in the cargo bucket, if needed. The front arch support 72 along with struts 73 support the accessory plate and motor assembly in the area above the front wheel and in front of the cargo bucket. Front arch support 72 and struts 73 couple the accessory plate 56 solidly to main support member 18. Front arch support also acts as a type of brush guard for deflecting obstacles, such as bushes, away from the front wheel and motor, thereby reducing snags which can occur during travel across undeveloped terrain. A gravel chute 74 can also be attached to the wheelbarrow 10 which is mounted to the top of the arch support. The gravel chute 74 helps to avoid dumping gravel or dirt on the motor and its associated components.

The braking system can be set up in a number of arrangements, but it has been found that lightweight, yet heavy-duty mountain bike-style disc brakes operate well, even under heavy loads. The discs 76 are attached to the front and rear inline wheels and operated with two hand brake levers 48 located on the handles 30 along with the levers 48 used to operate the catch release and throttle.

The inventive wheelbarrow also incorporates the features of a cargo securing means 78 such as cargo hooks, loops or holes located on or proximate to the upper rim of the cargo bucket 24. Rope or cargo netting can be attached to the cargo securing means 78 for retaining cargo within the cargo bucket 24. It is also envisioned that the cargo bucket 24 could be interchangeable with other cargo buckets, lumber racks, hunting racks, and the like.

Accordingly, the inventive wheelbarrow described herein reduces operator fatigue and provides a motorized wheelbarrow alternative which extends the usability of a wheelbarrow in moving heavy cargoes.

Finally, although the description above contains many specificities, these should not be construed as limiting the scope of the invention but as merely providing illustrations of some of the presently preferred embodiments of this invention. This invention may be altered and rearranged in numerous ways by one skilled in the art without departing from the coverage of the appended claims.

1. A wheelbarrow, comprising:
a frame;
a pair of handles communicating with said frame;
said frame further comprising elevating means for raising or lowering at least one of said handles.

2. The wheelbarrow of claim 1, further comprising at least one wheel mounted to said frame and a cargo bucket mounted to said frame substantially above said wheel.

3. The wheelbarrow of claim 2, wherein said wheel is a drive wheel, said drive wheel operatively communicating with a drive motor, said drive motor mounted to said frame.

4. The wheelbarrow of claim 2, further comprising a gravel chute mounted forward of said cargo bucket.

5. The wheelbarrow of claim 2, further comprising cargo securing means for securing cargo placed within said cargo bucket.

6. The wheelbarrow of claim 5, wherein said cargo securing means are a plurality of holes imparted through said cargo bucket proximate to and along an upper rim of said cargo bucket.

7. The wheelbarrow of claim 1, wherein said handles are detachable.

8. The wheelbarrow of claim 2, further comprising braking means for braking said wheel.

9. The wheelbarrow of claim 1, further comprising a pair of wheels mounted to said frame and a cargo bucket mounted to said frame above said wheels.

10. The wheelbarrow of claim 9, wherein said pair of wheels are mounted to said frame in an inline orientation.

11. The wheelbarrow of claim 10, wherein at least one of said pair of wheels is a drive wheel, said drive wheel operatively communicating with a drive motor, said drive motor mounted to said frame.

12. The wheelbarrow of claim 9, further comprising a gravel chute mounted forward of said cargo bucket.

13. The wheelbarrow of claim 9, further comprising braking means for braking at least one of said pair of wheels.

14. The wheelbarrow of claim 9, further comprising cargo securing means for securing cargo placed within said cargo bucket.

15. The wheelbarrow of claim 14, wherein said cargo securing means are a plurality of holes imparted through said cargo bucket proximate to and along an upper rim of said cargo bucket.

16. A wheelbarrow comprising:
a pair of inline wheels supporting a frame, wherein a cargo bucket is coupled to said frame substantially above said inline wheels, said frame further comprising an elevating means communicating with a pair of handles, said elevating means for articulating said handles into a raised or lowered position.

17. A wheelbarrow comprising:
a pair of inline wheels supporting a frame, wherein a cargo bucket is coupled to said frame substantially above said inline wheels.

18. The wheelbarrow of claim 17, wherein at least one of said inline wheels is a drive wheel, said drive wheel operatively communicating with a drive motor, said drive motor mounted to said frame.

19. The wheelbarrow of claim 17, further comprising a gravel chute mounted forward of said cargo bucket.

20. The wheelbarrow of claim 17, further comprising cargo securing means for securing cargo placed within said cargo bucket.

21. The wheelbarrow of claim 20, wherein said cargo securing means are a plurality of holes imparted through said cargo bucket proximate to and along an upper rim of said cargo bucket.

22. The wheelbarrow of claim 17, further comprising a pair of handles communicating with said frame.

23. The wheelbarrow of claim 22, further comprising elevating means operatively communicating with said frame, said elevating means for raising or lowering at least one of said handles.
